SEQUENCE LISTING (1 sequence)

SEQ ID NO: 1 - protein, 316 aa, Bacillus thermoproteolyticus
ITGTSTVGVGRGVLGDQKNINTTYSTYYYLQDNTRGNGIFTYDAKYRTTLPGSLWADADNQFFASYDAPAVDAHYYAGVTYDYYKNVHNRLSYDGNNAAIRSSVHYSQGYNNAFWNGSQMVYGDGDGQTFIPLSGGIDVVAHELTHAVTDYTAGLIYQNESGAINEAISDIFGTLVEFYANKNPDWEIGEDVYTPGISGDSLRSMSDPAKYGDPDHYSKRYTGTQDNGGVHINSGIINKAAYLISQGGTHYGVSVVGIGRDKLGKIFYRALTQYLTPTSNFSQLRAAAVQSATDLYGSTSQEVASVKQAFDAVGVK

(19) United States
(12) Patent Application Publication
(10) Pub. No.: US 2026/0275247 A1
(43) Pub. Date: Sep. 17, 2026

(54) METHODS AND COMPOSITIONS FOR CLEANING

(71) Applicants: Danisco US Inc., Palo Alto, CA (US); International Flavors & Fragrances, New York, NY (US)

(72) Inventors: JONATHAN LASSILA, SOUTH SAN FRANCISCO, CA (US); DJURRE POSTMA, HILVERSUM (NL)

(21) Appl. No.: 18/872,034

(22) PCT Filed: Jun. 19, 2023
(86) PCT No.: PCT/US2023/068672

§ 371 Date: Dec. 5, 2024

Related U.S. Application Data
(60) Provisional application No. 63/353,986, filed on Jun. 21, 2022.

(51) Int. Cl. C11D 3/386; C11D 3/50

(52) U.S. Cl. CPC C11D 3/38618; C11D 3/38636; C11D 3/50; C11D 2111/12; C11D 2111/14

(57) ABSTRACT

The present disclosure is directed towards compositions and methods for cleaning. More specifically, the present disclosure relates to compositions and methods for mitigating malodors associated with items, such as but not limited to, a textile or machine, wherein the machine is a laundry machine or a dishwasher.

This application is a 371 of International Patent Application No. PCT/US2023/068672, filed Jun. 19, 2023, which claims the benefit of U.S. Provisional Application No. 63/353,986, filed Jun. 21, 2022, each of which are incorporated herein by reference in their entirety.

The present disclosure relates to compositions and methods cleaning, for example hard surface and laundry cleaning and mitigation of malodor from a textile, hard surface, or dishware.

### REFERENCE TO SEQUENCE LISTING SUBMITTED ELECTRONICALLY

The official copy of the sequence listing is submitted electronically via Patent Center as an XML formatted sequence listing with a file named 20230613_NB42099PCT_SeqListing created on Jun. 13, 2023 and having a size of 2,128 bytes and is filed concurrently with the specification. The sequence listing contained in this XML formatted document is part of the specification and is herein incorporated by reference in its entirety.

### BACKGROUND

Trends toward cold water washing and synthetic athletic wear are driving a need for detergents that eliminate malodor, while at the same time the industry is moving away from laundry powders where traditional oxygen bleach was feasible. Thus, a need exists for new approaches to remove malodor associated with laundry and laundry machines.

Despite repeated exposure to surfactants, proteases, and amylases from typical laundry detergents, malodor compounds persist in washing machines and fabrics and textiles and contribute to hygiene and odor problems. More effective solutions for mitigating malodor and improving freshness in in cleaning applications, such as laundry are thus needed.

### SUMMARY

One embodiment is directed to methods for mitigating or treating malodor in a textile or machine comprising (i) contacting a textile or machine with a composition comprising: a) 0.2 to 100 parts per million (PPM) of a polypeptide having thermolysin activity; b) 0.00001% to about 2% of a fragrance; and c) at least one detergent adjuvant, and (ii) optionally rinsing the textile or machine.

Another embodiment is directed to methods for cleaning an item, comprising contacting an item in need of cleaning with a composition comprising a) 0.2 to 100 parts per million (PPM) of a polypeptide having thermolysin activity; b) 0.00001% to about 2% of a fragrance; and c) at least one detergent adjuvant, and (ii) optionally rinsing the item.

In another embodiment, methods are provided for improving the freshness of an item after a washing process, comprising contacting an item with a composition comprising a) 0.2 to 100 parts per million (PPM) of a polypeptide having thermolysin activity; b) 0.00001% to about 2% of a fragrance; and c) at least one detergent adjuvant, and (ii) optionally rinsing the item.

In yet another embodiment, the disclosure provides the use of a polypeptide having thermolysin activity in a detergent composition for increasing the freshness associated with a perfume to a textile after a laundering process, or for enhancing the effect of a perfume in a detergent composition, where the detergent comprises at least one perfume compound.

The disclosure further provides an enzyme-fragrance system comprising from about 0.2 to 100 PPM of a polypeptide having thermolysin activity; and from about 0.00001% to about 2% of a fragrance.

Further provided herein are detergent compositions comprising, from about 0.2 to 100 PPM of a polypeptide having thermolysin activity, from about 0.00001% to about 2% of a fragrance, and optionally at least one detergent adjunct material.

### DESCRIPTION

The present disclosure provides compositions (e.g. enzyme and detergent compositions) and methods using such compositions for the mitigation of malodor, for example, from an article, such as a hard surface or textile. The present disclosure also provides compositions (e.g. enzyme and detergent compositions) and methods using such compositions for improving the freshness of an item, for example, from an article, such as a hard surface or textile. The compositions generally employ the use of an enzyme-fragrance combination comprising at least one polypeptide having thermolysin activity and a perfume or a composition comprising a polypeptide having thermolysin activity and a perfume. The compositions also optionally comprise additional components of a cleaning detergent, such as one or more surfactants.

Prior to describing embodiments of present compositions and methods, the following terms are defined.

Unless defined otherwise herein, all technical and scientific terms used herein have the same meaning as commonly understood by one of ordinary skill in the art to which this invention pertains. Although any methods and materials similar or equivalent to those described herein find use in the practice of the present invention, the preferred methods and materials are described herein. Accordingly, the terms defined immediately below are more fully described by reference to the specification as a whole. Also, as used herein, the singular terms “a,” “an,” and “the” include the plural reference unless the context clearly indicates otherwise. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The term “malodor” refers to any odor that is not desired or intended on an item, for example after cleaning. Examples of malodor include volatile compounds with a perceived unpleasant smell, which may be produced by microorganisms. The microorganisms may be gram positive or gram-negative bacteria (aerobic or anaerobic); algae, protozoa, and/or yeast or filamentous fungi. In some embodiments the malodor may be associated with one or more microorganisms, including one or more bacterial genera of Acinetobacter sp., Aeromicrobium sp., Brevundimonas sp., Microbacterium sp., Micrococcus luteus, Pseudomonas sp. (e.g. Pseudomonas fluorescens), Staphylococcus sp. (e.g. Staphylococcus epidermidis), and Stenotrophomonas sp., Streptomyces sp., Listeria sp., Streptococcus sp., and Escherichia sp. Another example of malodor includes unpleasant smells which can be sweat, or body odor associated with an item that has been in contact with a human or animal. Another example includes odors from spices that adhere to items, such as curry or other spices with a smell.

The term “fragrance effect” as used here refers to the human perception of a fragrance on a washed item, such as a fabric (e.g. laundered clothing). The fragrance effect of an enzyme-fragrance combination or composition comprising an enzyme-fragrance combination as provided herein can be analyzed, for example, by the use of a sensory evaluation, such as that described in Example 1, 2, or 5 below. Alternatively, the fragrance effect can be measured by GC-MS analysis and expressed quantitatively as a fragrance intensity. An increased fragrance effect can thus be expressed as an increased fragrance intensity, such that washing an item with a polypeptide having thermolysin activity and a fragrance or a composition comprising a polypeptide having thermolysin activity and a fragrance compared to a similar item not having been washed with the polypeptide having thermolysin activity and a fragrance or composition comprising a polypeptide having thermolysin activity and a fragrance, or compared to the same item prior to washing.

As used herein, “surface” means any surface, including hard, soft, and porous surfaces. Hard surfaces include, but are not limited to metal, glass, ceramics, wood, minerals (rock, stone, marble, granite), aggregate materials such as concrete, plastics, composite materials, hard rubber materials, and gypsum. The hard materials may be finished with enamels and paints. Hard surfaces are found, for example in water treatment and storage equipment and tanks; dairy and food processing equipment and facilities; medical equipment and facilities, such as surgical instruments and permanent and temporary implants; industrial pharmaceutical equipment and plants. Soft surfaces are, for example, hair and all types of textiles. Porous surfaces also may be found in certain ceramics as well as in membranes that are used for filtration. Other surfaces include, but are not limited to, ship hulls and swimming pools. Other surfaces may be biological surfaces, such as skin, keratin or internal organs.

The term “fabric” refers to, for example, woven, knit, and non-woven material, as well as staple fibers and filaments that can be converted to, for example, yarns and woven, knit, and non-woven fabrics. The term encompasses material made from natural, as well as synthetic (e.g., manufactured) fibers.

The term “textile”, as used herein, refers to any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used, it is intended to include the broader term textiles as well. In the context of the present application, the term “textile” is used interchangeably with fabric and cloth.

As used herein, the term “hard surface” refers to any article having a hard surface including floors, tables, walls, roofs etc. as well as surfaces of hard objects such as cars (car wash), ship hulls, dishes (dishware), medical instruments, pipes, reservoirs, or holding tanks. The term “hard surface” includes also the surfaces of flexible yet firm objects such as the insides of bendable tubing and supply lines or the surfaces of deformable holding tanks or vessels. The term “hard surface” includes also the surfaces in the interior of washing machines, such as the interior of laundry washing machines or dishwashing machines, this includes soap intake box, walls, windows, baskets, racks, nozzles, pumps, sump, filters, pipelines, tubes, joints, seals, gaskets, fittings, impellers, drums, drains, traps, coin traps inlet and outlets. The term hard surface does not encompass textile or fabric.

The term “laundering” includes both household laundering and industrial laundering and means the process of treating textiles with a solution containing a cleaning or detergent composition as provided herein. The laundering process can for example be carried out using e.g. a household or an industrial washing machine or can be carried out by hand.

The term “wash cycle” refers to a washing operation in which textiles are immersed in a wash liquor, mechanical action of some kind is applied to the textile to release stains or to facilitate flow of wash liquor in and out of the textile and finally the superfluous wash liquor is removed. After one or more wash cycles, the textile is generally rinsed and dried.

The term “wash liquor” is defined herein as the solution or mixture of water and detergent components optionally including polypeptides having thermolysin activity and a perfume.

### Cleaning Methods

In one embodiment, methods for preventing, reducing or removing a malodor are provided, where the methods comprise contacting an item with a polypeptide having thermolysin activity and a perfume or a composition comprising a polypeptide having thermolysin activity and a perfume.

In another embodiment, the disclosure provides a method for preventing, reducing or removing a malodor associated with a textile or hard surface, where the method comprises contacting a textile or hard surface with a polypeptide having thermolysin activity and a perfume, or a composition comprising a polypeptide having thermolysin activity and a perfume, and optionally rinsing the textile or hard surface.

In another embodiment, the disclosure provides methods for reducing malodor associated with a textile or hard surface comprising: (i) contacting a textile or hard surface with a polypeptide having thermolysin activity and a perfume or a composition comprising a polypeptide having thermolysin activity and a perfume; and (ii) optionally, rinsing the textile or surface. In some embodiments, the textile or hard surface comprises a proteinaceous on a surface of the textile or hard surface. In some embodiments, the malodor is reduced at least 5%, 10%, 15%, 20%, 25%, 30%, 35%, 40%, 45%, 50%, 55%, 60%, 65%, 70%, 75%, 80%, 85%, 90%, 95% or greater compared to the amount of the malodor present prior to contacting the textile or hard surface with the polypeptide having thermolysin activity and a perfume or a composition comprising a polypeptide having thermolysin activity and a perfume.

In some embodiments, the malodor is reduced at least 5%, 10%, 15%, 20%, 25%, 30%, 35%, 40%, 45%, 50%, 55%, 60%, 65%, 70%, 75%, 80%, 85%, 90%, 95% or greater after 1, 2, 3, 4, or 5 or more wash cycles compared to the amount of the malodor present in a textile or hard surface not contacted with the polypeptide having thermolysin activity and a perfume or a composition comprising a polypeptide having thermolysin activity and a perfume.

The textile or surface can be contacted with the polypeptide and perfume or a composition comprising the polypeptide having thermolysin activity and a perfume in a washing machine or in a manual wash tub (e.g. for handwashing). In one embodiment, the textile or surface is contacted with the polypeptide having thermolysin activity and a perfume or the composition comprising a peptide having thermolysin activity and a perfume in a wash liquor. In another embodiment, a solution containing the polypeptide having thermolysin activity and a perfume is incubated with or flowed over the hard surface, such as by pumping the solution through tubing or pipes or by filling a reservoir with the solution.

In some embodiments, the textiles or surfaces are contacted with the polypeptide and a perfume or compositions comprising the polypeptide and a perfume under conditions for any amount of time desired or for any period of time sufficient to prevent, reduce or remove malodor from the textile. In one embodiment, the contacting step is between about 5 minutes and about 10 days. In some embodiments, the contacting takes place in a wash liquor for about 5 to about 400 minutes, between about 5 minutes to about 300 minutes, between about 5 minutes to about 250 minutes, between about 5 minutes to about 200 minutes, between about 5 minutes to about 150 minutes, between about 5 minutes to about 100 minutes, between about 5 minutes to about 50 minutes, between about 5 minutes to about 30 minutes.

In some embodiments, the textiles or articles are contacted with the polypeptide and a perfume or compositions comprising the polypeptide and a perfume under conditions having a temperature that allows for malodor prevention, reduction or removal from the textile or article. In some embodiments, the temperature in the methods disclosed herein include those between 10° to 60° C., between 10° to about 45° C., between 15° to about 55° C., between 15° to about 50° C., between 15° to about 45° C., between 20° to about 60° C., between 20° to about 50° C. and between 20° to about 45° C.

The polypeptides, compositions, and methods provided herein have utility in a wide array of applications in which preventing, reducing, or removing malodor is desired, such as household cleaning, including in washing machines, dishwashers, and on household surfaces.

The polypeptides, compositions, and methods provided herein further have utility in a wide array of applications in which improving the fragrance effect of a given fragrance is desired, such as household cleaning, including in washing machines, dishwashers, and on household surfaces.

Another embodiment is directed to a method of laundering a textile, where the method comprises contacting a textile with a polypeptide having thermolysin activity and a perfume, or a composition comprising a polypeptide having thermolysin activity and a perfume for an amount of time sufficient to prevent, reduce or remove a malodor from the textile and optionally rinsing the textile.

Another embodiment is directed to a method for cleaning an article, where the method comprises contacting the article with a polypeptide having thermolysin activity and a perfume or a composition having a polypeptide having thermolysin activity and a perfume under conditions sufficient reduce a malodor from the article, and optionally rinsing the article.

### Compositions

In one embodiment, the disclosure provides compositions (e.g. detergent compositions) for use in the methods provided herein. The compositions generally comprise a polypeptide having thermolysin activity and a fragrance and optionally one or more additional detergent components, such as a surfactant.

The compositions having a polypeptide having thermolysin activity and a fragrance, which find use in the methods provided herein, may comprise a polypeptide having thermolysin activity at a concentration of in use of 0.001 to 10,000 mg/L, or 0.001 to 2000 mg/L, or 0.01 to 5000 mg/L, or 0.01 to 2000 mg/L, or 0.01 to 1300 mg/L, or 0.1 to 5000 mg/L, or 0.1 to 2000 mg/L, or 0.1 to 1300 mg/L, or 1 to 5000 mg/L, or 1 to 1300 mg/L, or 1 to 500 mg/L, or 10 to 5000 mg/L, or 10 to 1300 mg/L, or 10 to 500 mg/L. In another embodiment, the composition may contain a polypeptide having thermolysin activity in an amount of 0.002 to 5000 mg of protein, such as 0.005 to 1300 mg of protein, or 0.01 to 5000 mg of protein, or 0.01 to 1300 mg of protein, or 0.1 to 5000 mg of protein, or 1 to 1300 mg of protein, preferably 0.1 to 1300 mg of protein, more preferably 1 to 1300 mg of protein, even more preferably 10 to 500 mg of protein, per liter of wash liquor, or in the amount of at least 0.002 ppm active thermolysin. In another embodiment, the detergent composition comprises a polypeptide having thermolysin activity in an amount to provide the thermolysin in a wash liquor in an amount of between 0.1 to 5000 ppm, between about 0.1 to 2500 ppm, between about 0.1 to 1500 ppm, between about 0.1 to 1300 ppm, between about 0.1 to 1000 ppm, between about 0.1 to 500 ppm, between 1 to 1300 ppm, between 10 to 1300 ppm, between about 10 and 500 PPM, between about 50 and 1300 ppm, between about 50 and 500 ppm in the wash liquor.

The compositions having a polypeptide having thermolysin activity and a perfume, which find use in the methods provided herein, may comprise a perfume in an amount sufficient to provide a wash liquor an amount of perfume of about 0.001%, 0.0005%, 0.0002%, or 0.0001%.

In one embodiment, the composition comprises a thermolysin, a fragrance, and at least one additional detergent component, and optionally one or more additional enzymes.

The thermolysin polypeptide for use in the methods and compositions herein includes any thermolysin polypeptide. As used herein, the term “thermolysin” refers to enzymes with E.C. 3.4.24.X, or any member of the M4 protease family as described in MEROPS—The Peptidase Data base (See, Rawlings et al., MEROPS: the peptidase database, Nucl Acids Res, 34 Database issue, D270-272 [2006]), of which thermolysin (TLN; EC 3.4.24.27) is the prototype. The amino acid sequence of one embodiment of thermolysin is the neutral metallo endo-peptidase secreted from Bacillus thermoproteolyticus and the sequence set forth as UniProtKB/Swiss-Prot Accession No. P00800 (SEQ ID NO:1). Thermolysin polypeptide includes homologs, variants and active fragments of SEQ ID NO: 1. The terms “thermolysin,” “stearolysin”, “bacillolysin,” “proteinase-T”, “PrT”, “Thermolysin-like protease”, and “TLPs”, are used interchangeably herein to refer to the neutral metalloprotease enzyme having the amino acid sequence of SEQ ID NO: 1, or those having at least 60%, 65%, 70%, 75%, 80%, 85%, 90%, 95%, or greater sequence identity to SEQ ID NO: 1.

As used herein, “homologous genes” refers to a pair of genes from different, but usually related species, which correspond to each other and which are identical or very similar to each other. The term encompasses genes that are separated by speciation (i.e., the development of new species) (e.g., orthologous genes), as well as genes that have been separated by genetic duplication (e.g., paralogous genes).

As used herein, the term “variant polypeptide” refers to a polypeptide comprising an amino acid sequence that differs in at least one amino acid residue from the amino acid sequence of a parent or reference polypeptide (including but not limited to wild-type polypeptides).

As used herein, “the genus Bacillus” includes all species within the genus “Bacillus,” as known to those of skill in the art, including but not limited to B. subtilis, B. licheniformis, B. lentus, B. brevis, B. stearothermophilus, B. alkalophilus, B. amyloliquefaciens, B. clausii, B. halodurans, B. megaterium, B. coagulans, B. circulans, B. lautus, and B. thuringiensis. It is recognized that the genus Bacillus continues to undergo taxonomical reorganization. Thus, it is intended that the genus include species that have been reclassified, including but not limited to such organisms as B. stearothermophilus, which is now named “Geobacillus stearothermophilus.” The production of resistant endospores in the presence of oxygen is considered the defining feature of the genus Bacillus, although this characteristic also applies to the recently named Alicyclobacillus, Amphibacillus, Aneurinibacillus, Anoxybacillus, Brevibacillus, Filobacillus, Gracilibacillus, Halobacillus, Paenibacillus, Salibacillus, Thermobacillus, Ureibacillus, and Virgibacillus.

In some embodiments, the thermolysin for use in the compositions and methods provided herein includes a polypeptide having an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1. In some embodiments, the thermolysin has an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1 and has thermolysin activity. In some embodiments, the thermolysin has an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1 and has the ability to prevent, reduce or remove odor causing residues in laundry. In some embodiments, the thermolysin has an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1 and has the ability to clean body soil stains. In some embodiments, the thermolysin has an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1 and has the ability to reduce malodor by 5%, 10%, 20%, 30%, 40%, 50%, 60%, 70%, 80%, 90%, or 100% relative to a control not treated with enzyme.

As used herein, “thermolysin activity” and “proteolytic activity” refers to a protein or polypeptide exhibiting the ability to hydrolyze peptides or substrates having peptide linkages. Methods for measuring proteolytic activity are known, and include comparative assays, which analyze the respective protease's ability to hydrolyze a commercial substrate. Other methods include those provided herein. Exemplary substrates useful in the analysis of protease or proteolytic activity, include, but are not limited to, di-methyl casein (Sigma C-9801), bovine collagen (Sigma C-9879), bovine elastin (Sigma E-1625), and bovine keratin (ICN Biomedical 902111). Colorimetric assays utilizing these substrates are well known in the art (See e.g., WO99/34011 and U.S. Pat. No. 6,376,450). The pNA peptidyl assay (See e.g., Del Mar et al., Anal Biochem, 99:316-320, 1979) also finds use in determining the active enzyme concentration. This assay measures the rate at which p-nitroaniline is released as the enzyme hydrolyzes a soluble synthetic substrate, such as succinyl-alanine-alanine-proline-phenylalanine-p-nitroanilide (suc-AAPF-pNA). The rate of production of yellow color from the hydrolysis reaction is measured at 405 or 410 nm on a spectrophotometer and is proportional to the active enzyme concentration. In addition, absorbance measurements at 280 nanometers (nm) can be used to determine the total protein concentration in a sample of purified protein. The activity on substrate/protein concentration gives the enzyme specific activity.

As used herein, “% identity or percent identity” refers to sequence similarity. Percent identity may be determined using standard techniques known in the art (See e.g., Smith and Waterman, Adv. Appl. Math. 2:482 [1981]; Needleman and Wunsch, J. Mol. Biol. 48:443 [1970]; Pearson and Lipman, Proc. Natl. Acad. Sci. USA 85:2444 [1988]; software programs such as GAP, BESTFIT, FASTA, and TFASTA in the Wisconsin Genetics Software Package (Genetics Computer Group, Madison, WI); and Devereux et al., Nucl. Acid Res. 12:387-395 [1984]). One example of a useful algorithm is PILEUP. PILEUP creates a multiple sequence alignment from a group of related sequences using progressive, pair-wise alignments. It can also plot a tree showing the clustering relationships used to create the alignment. PILEUP uses a simplification of the progressive alignment method of Feng and Doolittle (See, Feng and Doolittle, J. Mol. Evol. 35:351-360 [1987]). The method is similar to that described by Higgins and Sharp (See, Higgins and Sharp, CABIOS 5:151-153 [1989]). Useful PILEUP parameters include a default gap weight of 3.00, a default gap length weight of 0.10, and weighted end gaps. Other useful algorithm is the BLAST algorithms described by Altschul et al., (See, Altschul et al., J. Mol. Biol. 215:403-410 [1990]; and Karlin and Altschul, Proc. Natl. Acad. Sci. USA 90:5873-5787 [1993]). The BLAST program uses several search parameters, most of which are set to the default values.

As used herein, “homologous proteins” or “homologous proteases” refers to proteins that have distinct similarity in primary, secondary, and/or tertiary structure. Protein homology can refer to the similarity in linear amino acid sequence when proteins are aligned. Homology can be determined by amino acid sequence alignment, e.g., using a program such as BLAST, MUSCLE, or CLUSTAL. Homologous search of protein sequences can be done using BLASTP and PSI-BLAST from NCBI BLAST with threshold (E-value cut-off) at 0.001. (Altschul et al., “Gapped BLAST and PSI BLAST a new generation of protein database search programs”, Nucleic Acids Res, Set 1; 25 (17): 3389-402 (1997)). The BLAST program uses several search parameters, most of which are set to the default values. The NCBI BLAST algorithm finds the most relevant sequences in terms of biological similarity but is not recommended for query sequences of less than 20 residues (Altschul et al., Nucleic Acids Res, 25:3389-3402, 1997 and Schaffer et al., Nucleic Acids Res, 29:2994-3005, 2001). Exemplary default BLAST parameters for a nucleic acid sequence searches include: Neighboring words threshold=11; E-value cutoff=10; Scoring Matrix=NUC.3.1 (match=1, mismatch=−3); Gap Opening=5; and Gap Extension=2. Exemplary default BLAST parameters for amino acid sequence searches include: Word size=3; E-value cutoff=10; Scoring Matrix=BLOSUM62; Gap Opening=11; and Gap extension=1. Using this information, protein sequences can be grouped and/or a phylogenetic tree built therefrom. Amino acid sequences can be entered in a program such as the Vector NTI Advance suite and a Guide Tree can be created using the Neighbor Joining (NJ) method (Saitou and Nei, Mol Biol Evol, 4:406-425, 1987). The tree construction can be calculated using Kimura's correction for sequence distance and ignoring positions with gaps. A program such as AlignX can display the calculated distance values in parentheses following the molecule name displayed on the phylogenetic tree.

A percent (%) amino acid sequence identity value is determined by the number of matching identical residues divided by the total number of residues of the “reference” sequence including any gaps created by the program for optimal/maximum alignment. If a sequence is 90% identical to SEQ ID NO: A, SEQ ID NO: A is the “reference” sequence. BLAST algorithms refer the “reference” sequence as “query” sequence.

The CLUSTAL W algorithm is another example of a sequence alignment algorithm (See, Thompson et al., Nucleic Acids Res, 22:4673-4680, 1994). Default parameters for the CLUSTAL W algorithm include: Gap opening penalty=10.0; Gap extension penalty=0.05; Protein weight matrix=BLOSUM series; DNA weight matrix=IUB; Delay divergent sequences %=40; Gap separation distance=8; DNA transitions weight=0.50; List hydrophilic residues=GPSNDQEKR; Use negative matrix=OFF; Toggle Residue specific penalties=ON; Toggle hydrophilic penalties=ON; and Toggle end gap separation penalty=OFF. In CLUSTAL algorithms, deletions occurring at either terminus are included. For example, a variant with a five amino acid deletion at either terminus (or within the polypeptide) of a polypeptide of 500 amino acids would have a percent sequence identity of 99% (495/500 identical residues×100) relative to the “reference” polypeptide. Such a variant would be encompassed by a variant having “at least 99% sequence identity” to the polypeptide.

In some embodiments, the thermolysin for use herein includes those thermolysin polypeptides described in WO2015/066669.

In some embodiments, the thermolysin polypeptide for use herein includes variants of thermolysin, including those disclosed in WO2014071410 and US20140099698, US201880073006, EP3260538, and US20180066244.

Fragrances, or perfumes, for use in the compositions and methods herein include any fragrance/perfume available. The term “fragrance” or “perfume” includes raw materials and compositions, accords, scents and oils, for example essential oils. A wide variety of chemicals are known for fragrance (i.e., perfume) uses, including compounds such as aldehydes, ketones and esters. Also naturally occurring plant and animal oils and exudates comprising complex mixtures of various chemical components are known for use as fragrances.

A perfume may be a blend of volatile compounds with different volatilities which can bind to receptors in the nose and therefore has a smell or odor, usually a pleasant one. These compounds are also known as odorants or fragrances. Most perfumes possess molar weights of up to approximately 200 g/mol, in some cases up to about 300 g/mol. Larger molecules are not volatile enough to be perceived by the human nose.

The volatility of a compound describes how readily it vaporizes by way of evaporation or boiling. Perfume compounds vaporize, depending on their volatility, by evaporation at room temperature and atmospheric pressure. Volatility is often described using vapor pressure or boiling point, with a high vapor pressure or low boiling point indicating a high volatility. Although the volatility of a compound is related to its molecular weight, other factors such as structure and polarity also play a role, as does interaction between fragrance compounds.

The most volatile fragrance compounds are referred to as top notes or head notes, whereas increasingly less volatile compounds are referred to as heart notes or middle notes, and the least volatile as base notes or back notes. The top notes are responsible for the first impression of a detergent, and the heart notes represent the characteristic smell. The base notes ensure the more substantial, long-lasting effect of the perfume.

The top, heart (middle) and base notes may be grouped based in different criteria. One such grouping is that of Poucher (Poucher, W. A. (1993). Poucher's Perfumes, Cosmetics and Soaps, Vol. 2 (Ninth ed.), Chapman & Hall, page 55). Poucher classified fragrance compounds according to an evaporation coefficient, with top notes having a coefficient of from 1 to 14, middle notes having a coefficient of from 15 to 60, and base notes having a coefficient of from 61 to 100.

Information regarding fragrance compounds such as molecular weight, vapor pressure and boiling point may also indicate whether particular fragrance compounds are top notes, middle notes or base notes. Such information may be obtained at iff.com/portfolio/products/fragrance-ingredients/online-compendium and at shop.perfumersapprentice.com.

The duration of the “freshness” or “cleanliness” effect provided by a perfume in a detergent composition is influenced by how fragrances and malodors are retained on the washed fabric. Laundry malodors can come from various sources, including human body odor as well as malodors from the environment such as kitchen odors, cigarettes, food stains, etc. Another important source of malodors is from microbes present in the textile, which can metabolize the substances transferred from the human body (sweat, dead cells, sebum, etc.) and generate malodors during drying, storage or wearing.

Material type may also be an important factor in retaining and release of odor compounds. For example, malodor compounds may be more effectively removed from cotton than from polyester. This is partly related to the polarity (hydrophilicity) of the odor compounds and that of the textile fibers, with cotton containing mainly highly polar cellulosic fibers, while fibers of polyester and wool are relatively non-polar compared to cotton fibers. In general, the order of compound polarity of fragrance compounds from high to low is as follows; Amide>Acid>Alcohol>Ketone~ Aldehyde>Ester>Alkane.

Fragrance compounds used in laundry detergents may be chemical compounds from any of several different classes or essential oils or other natural compounds. The perfumes that may be used in the context of the present disclosure include all perfumes. Thus, in particular synthetic or natural odorant substance compounds of the types esters, ethers, aldehydes (fragrance aldehydes, odorant aldehydes), ketones (fragrance ketones, odorant ketones), alcohols, hydrocarbons, acids, carbonic acid esters, aromatic hydrocarbons, aliphatic hydrocarbons, saturated and/or unsaturated hydrocarbons and mixtures of these may be used as perfume compounds.

Individual fragrance compounds, e.g. synthetic products of the ester, ether, aldehyde, ketone, alcohol, and hydrocarbon types, can be used as well as mixtures thereof. It is preferred, however, to use mixtures of different perfume compounds, which together generate an attractive scent note. Such mixtures can also contain natural perfume mixtures such as those accessible from plant sources, e.g. pine, citrus, jasmine, patchouli, rose or ylang-ylang oil.

Fragrances that find use in the compositions and methods herein include, but are not limited to those provided below.

Suitable perfumes of the ester type include e.g. benzyl acetate, phenoxy ethyl isobutyrate, p-tert-butyl cyclohexyl acetate, linalyl acetate, dimethyl benzyl carbinyl acetate (DMBCA), phenylethyl acetate, ethyl methyl phenyl glycinate, allyl cyclohexyl propionate, styrallyl propionate, benzyl salicylate, cyclohexyl salicylate, floramate, melusate and jasmacyclate.

Odorant substance compounds of the hydrocarbon type include e.g. terpenes such as limonene and pinene.

Suitable perfumes of the ether type include e.g. benzyl ethyl ether and ambroxan.

Suitable perfume alcohols include e.g. 10-undecen-1-ol, 2,6-dimethyl heptan-2-ol, 2-methyl butanol, 2-methyl pentanol, 2-phenoxy ethanol, 2-phenyl propanol, 2-tert-butyl cyclohexanol, 3,5,5-trimethyl cyclohexanol, 3-hexanol, 3-methyl-5-phenyl pentanol, 3-octanol, 1-octen-3-ol, 3-phenyl propanol, 4-heptenol, 4-isopropyl cyclohexanol, 4-tert-butyl cyclohexanol, 6,8-dimethyl-2-nonanol, 6-nonen-1-ol, 9-decen-1-ol, alpha-methyl benzyl alcohol, alphaterpincol, amyl salicylate, benzyl alcohol, benzyl salicylate, beta-terpineol, butyl salicylate, citronellol, cyclohexyl salicylate, decanol, dihydro myrcenol, dimethyl benzyl carbinol, dimethyl heptanol, dimethyl octanol, ethyl salicylate, ethyl vanillin, anethol, eugenol, geraniol, heptanol, hexyl salicylate, isoborneol, isoeugenol, isopulegol, linalool, menthol, myrtenol, n-hexanol, nerol, nonanol, octanol, para-menthan-7-ol, phenyl ethyl alcohol, phenol, phenyl salicylate, tetrahydro geraniol, tetrahydro linalool, thymol, trans-2-cis-6-nonadienol, trans-2-nonen-1-ol, trans-2-octenol, undecanol, vanillin, and cinnamic alcohol, wherein when multiple perfume alcohols are present, they may be selected independently of one another.

Suitable perfume ketones can include all ketones that can lend a desired scent or a sensation of freshness. Mixtures of different ketones can also be used. For example the ketone can be selected from the group consisting of buccoxime, iso-jasmone, methyl-beta-naphthyl ketone, Moschus indanone, Tonalid/Moschus plus, alpha-damascone, beta-damascone, delta-damascone, isodamascone, damascenone, damarose, methyl dihydro jasmonate, menthone, carvone, campher, fenchone, alpha-ionene, beta-ionone, dihydro-beta-ionone, gamma-methyl ionone, fleuramone, dihydro jasmone, cis-jasmone, iso-B-Super, methyl cedrenyl ketone or methyl cedrylone, acetophenone, methyl acetophenone, para-methoxy acetophenone, benzyl acetone, benzophenone, para-hydroxy-phenyl butanone, celery ketone or livescone, 6-isopropyl decahydro-2-naphtone, dimethyl octenone, frescomenthe, 4-(1-ethoxyvinyl)-3,3,5,5-tetramethyl cyclohexanone, methyl heptenone, 2-(2-(4-methyl-3-cyclohexen-1-yl)-propyl)cyclopentanone, 1-(para-menthen-6 (2)-yl)-1-propanone, 4-(4-hydroxy-3-methoxy phenyl)-2-butanone, 2-acetyl-3,3-dimethyl norbomane, 6,7-dihydro-1,1,2,3,3-pentamethyl-4 (5H)-indanone, 4-damascol, dulcinyl or cassion, gelsone, hexalone, isocyclemone E, methyl cyclocitrone, methyl lavender ketone, orivone, para-tert-butyl cyclohexanone, verdone, delphone, muscone, neobutenone, plicatone, veloutone, 2,4,4,7-tetramethyl-oct-6-en-3-one, tetrameran, hedione and mixtures thereof. Preferred ketones may e.g. be selected from alpha-damascone, delta-damascone, isodamascone, carvone, gamma-methyl ionone, iso-E-super, 2,4,4,7-tetramethyl-oct-6-en-3-one, benzyl acetone, beta-damascone, damascenone, methyl dihydro jasmonate, methyl cedrylone, hedione and mixtures thereof.

Suitable perfume aldehydes can be any aldehydes that produce a desired scent or a sensation of freshness. They may be individual aldehydes or mixtures of aldehydes. Exemplary suitable aldehydes are melonal, triplal, ligustral, adoxal, anis aldehyde, cymal, ethyl vanillin, florhydral, helional, heliotropine, hydroxy citronellal, koavone, laurin aldehyde, lyral, methyl nonyl acetaldehyde, para-tert-bucinal, phenyl acetaldehyde, undecylene aldehyde, vanillin, 2,6,10-trimethyl-9-andecenal, 3-dodecen-1-al, alpha-n-amyl cinnamaldehyde, 4-methoxy benzaldehyde, benzaldehyde, 3-(4-tert-butylphenyl)-propanal, 2-methyl-3-(para-methoxy phenyl propanal), 2-methyl-4-(2,6,6-trimethyl-2 (1)-cyclohexen-1-yl)-butanal, 3-phenyl-2-propenal, cis-/trans-3,7-dimethyl-2,6-octadien-1-al, 3,7-dimethyl-6-octen-1-al, [(3,7-dimethyl-6-octenyl)-oxy]-acetaldehyde, 4-isopropyl benzyaldehyde, 1,2,3,4,5,6,7,8-octahydro-8,8-dimethyl-2-naphthaldehyde, 2,4-dimethyl-3-cyclohexen-1-carboxyaldehyde, 2-methyl-3-(isopropyl-phenyl)-propanal, decylaldehyde, 2,6-dimethyl-5-heptenal, 4-(tricyclo-[5.2.10-(2,6)]-decylidene-8)-butanal, octahydro-4, 7-methano-1H-indene carboxaldehyde, 3-ethoxy-4-hydroxy benzaldehyde, para-ethyl-alpha-alpha-dimethyl hydro cinnamaldehyde, alpha-methyl-3,4-(methylene dioxy)-hydro cinnamaldehyde, 3,4-methylene dioxy benzaldehyde, alpha-n-hexyl cinnamaldehyde, m-cymene-7-carboxaldehyde, alpha-methyl phenyl acetaldehyde, 7-hydroxy-3,7-dimethyl octanal, undecenal, 2,4,6-trimethyl-3-cyclohexene-1-carboxaldehyde, 4-(3)-(4-methyl-3-pentenyl)-3-cyclohexene carboxaldehyde, 1-dodecanal, 2,4-dimethyl cyclohexene-3-carboxaldehyde, 4-(4-hydroxy-4-methyl pentyl)-3-cyclohexene-1-carboxaldehyde, 7-methoxy-3,7-dimethyl octan-1-al, 2-methyl undecanal, 2-methyl decanal, 1-nonanal, 1-octanal, 2,6,10-trimethyl-5,9-undecadienal, 2-methyl-3-(4-tert-butyl)-propanal, dihydro cinnamaldehyde, 1-methyl-4-(4-methyl-3-pentenyl)-3-cyclohexene-1-carboxaldehyde, 5- or 6-methoxy hexahydro-4, 7-methano indane-1 or 2-carboxy aldehyde, 3,7-dimethyl octan-1-al, 1-undecanal, 10-undecen-1-al, 4-hydroxy-3-methoxy benzaldehyde, 1-methyl-3-(4-methyl pentyl)-3-cyclohexene carboxy aldehyde, trans-4-decenal, 2,6-nonadienal, para-tolyl-acetaldehyde, 4-methyl phenyl acetaldehyde, 2-methyl-4-(2,6,6-trimethyl-1-cyclohexen-1-yl)-2-butenal, ortho-methoxy cinnamaldehyde, 3,5,6-trimethyl-3-cyclohexene carboxaldehyde, 3,7-dimethyl-2-methylene-6-octenal, phenoxy acetaldehyde, 5,9-dimethyl-4,8-decadienal, peony aldehyde (6,1-dimethyl-3-oxa-5,9-undecadien-1-al), hexahydro-4,7-methanoindane-1-carboxaldehyde, 2-methyloctanal, alpha-methyl-4-(1-methyl ethylbenzene acetaldehyde, 6,6-dimethyl-2-norpinene-2-propion aldehyde, para-methyl phenoxy acetaldehyde, 2-methyl-3-phenyl-2-propen-1-al, 3,5,5-trimethyl hexanal, hexahydro-8, 8-dimethyl-2-naphthaldehyde, 3-propyl-bicyclo-[2.2.1]-hept-5-ene-2-carbaldehyde, 9-decenal, 3-methyl-5-phenyl-1-pentanal, 1-para-menthene-q-carboxaldehyde, citral or mixtures thereof, lilial citral, 1-decanal, 2, 4-dimethyl-3-cyclohexene-1-carboxaldehyde. Preferred aldehydes may e.g. be selected from cis/trans-3,7-dimethyl-2,6-octadien-1-al, heliotropin, 2,4,6-trimethyl-3-cyclohexene-1-carboxaldehyde, 2,6-nonadienal, alpha-n-amyl cinnamaldehyde, alpha-n-hexyl cinnamaldehyde, para-tert-bucinal, lyral, cymal, methyl nonyl acetaldehyde, trans-2-nonenal, lilial, trans-2-nonenal and mixtures thereof.

Perfume compounds may also be natural odorant mixtures such as those accessible from plant sources, e.g. pine, citrus, jasmine, patchouli, rose or ylang-ylang oil. Also suitable are muscat, sage oil, chamomile oil, clove oil, mint oil, cinnamon leaf oil, lime blossom oil, juniper berry oil, vetiver oil, olibanum (frankincense) oil, galbanum oil and labdanlum oil as well as orange blossom oil, neroli oil, orange peel oil and sandalwood oil. The perfume compounds may also be essential oils, e.g. angelica root oil, anise oil, arnica blossom oil, basal oil, bay oil, champaca blossom oil, silver fir oil, silver fir cone oil, elemi oil, eucalyptus oil, fennel oil, spruce needle oil, geranium oil, gingergrass oil, guaiac wood oil, gurjun balsam oil, helichrysum oil, ho leaf oil, ginger oil, iris oil, cajeput oil, calmus oil, camphor oil, canaga oil, cardamom oil, cassia oil, copaiva balsam oil, coriander oil, spearmint oil, caraway oil, cumen oil, lavender oil, lemongrass oil, lime oil, mandarin oil, lemon balm oil, musk seed oil, myrrh oil, niaouli oil, origanum oil, palmarosa oil, peru balsam oil, petit grain oil, pepper oil, peppermint oil, pimento oil, rosemary oil, celery oil, spike oil, stemanis oil, turpentine oil, thuja oil, thyme oil, verbena oil, vermouth oil, Wintergreen oil, ysop oil, cinnamon oil, citronella oil, lemon oil and cypress oil.

Further information about fragrance ingredients may be obtained from The International Fragrance Association (IFRA), which publishes a list of all fragrance ingredients used in consumer goods (ifrafragrance.org/initiatives/transparency/ifra-transparency-list).

In one embodiment a plurality of perfume compounds, e.g. those listed above or on the list maintained by the IFRA, may be included in a compositions provided herein in combination with the thermolysin polypeptide. The compositions of the invention may therefore e.g. contain three or more, such as four or more, five or more, six or more or seven or more different perfume components.

The compositions of the invention will typically contain one or more perfume components in a total amount (by weight) of from 0.0001% to 2.5%, such as 0.001-2%, e.g. 0.01-1.5%, for example 0.1-1% percent, based on the total amount of perfume components and the total weight of the composition. Alternatively, the compositions provided herein will contain one or more perfume components in an amount sufficient to provide a concentration in a wash solution of between about 0.0000001% to about 2%.

There are no limitations on the type of detergent composition in which perfumes may be incorporated. They may, for example, be included in detergent compositions that are in the form of liquids, gels, powders, granulates, tablets, pods, pouches and soap bars.

Perfume components may be incorporated into detergent compositions in physical forms and using methods known in the art, e.g. adding the perfume components as liquids, solid particles and/or microcapsules.

Thus, also provided are detergent compositions which find use in the methods provided herein. As used herein, the term “detergent composition” or “detergent formulation” is used in reference to a composition intended for use in a wash medium (e.g. a wash liquor) for the cleaning of soiled or dirty objects, including particular textile or non-textile objects or items. Such compositions of the present invention are not limited to any particular detergent composition or formulation. Indeed, in some embodiments, the detergents of the invention comprise at least one thermolysin or metalloprotease polypeptide (e.g. Proteinase T), a perfume and, in addition, one or more surfactants, transferase(s), hydrolytic enzymes, oxido reductases, builders (e.g., a builder salt), bleaching agents, bleach activators, bluing agents, fluorescent dyes, caking inhibitors, masking agents, enzyme activators, antioxidants, and/or solubilizers. In some instances, a builder salt is a mixture of a silicate salt and a phosphate salt, preferably with more silicate (e.g., sodium metasilicate) than phosphate (e.g., sodium tripolyphosphate). Some compositions of the invention, such as, but not limited to, cleaning compositions or detergent compositions, do not contain any phosphate (e.g., phosphate salt or phosphate builder).

In some embodiments, the cleaning or detergent compositions of the present invention further comprise adjunct materials including, but not limited to, surfactants, builders, bleaches, bleach activators, bleach catalysts, other enzymes, enzyme stabilizing systems, chelants, optical brighteners, soil release polymers, dye transfer agents, dispersants, suds suppressors, dyes, colorants, filler salts, hydrotropes, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, and pH control agents (See e.g., U.S. Pat. Nos. 6,610,642, 6,605,458, 5,705,464, 5,710,115, 5,698,504, 5,695,679, 5,686,014 and 5,646,101, all of which are incorporated herein by reference).

The detergent or cleaning compositions of the present invention are advantageously employed for example, in laundry applications, hard surface cleaning, dishwashing applications, as well as cosmetic applications such as dentures, teeth, hair and skin. In addition, due to the unique advantages of increased effectiveness in lower temperature solutions, the compositions of the present invention are ideally suited for laundry applications. Furthermore, the compositions of the present invention find use in granular and liquid compositions.

Enzyme component weights are based on total active protein. All percentages and ratios are calculated by weight unless otherwise indicated. All percentages and ratios are calculated based on the total composition unless otherwise indicated. In laundry detergent compositions, the enzyme levels are expressed in ppm, which equals mg active protein/kg detergent composition.

In some embodiments, the laundry detergent compositions described herein further comprise a surfactant. In some embodiments, the surfactant is selected from a non-ionic, ampholytic, semi-polar, anionic, cationic, zwitterionic, and combinations and mixtures thereof. In yet a further embodiment, the surfactant is selected from an anionic surfactant, a cationic surfactant, a zwitterionic surfactant, and combinations thereof. In some embodiments, the laundry detergent compositions described herein comprise from about 0.1% to about 60%, about 1% to about 50%, or about 5% to about 40% surfactant by weight of the composition.

Exemplary surfactants include, but are not limited to sodium dodecylbenzene sulfonate, C12-14 pareth-7, C12-15 pareth-7, sodium C12-15 pareth sulfate, C14-15 pareth-4, sodium laureth sulfate (e.g., Steol CS-370), sodium hydrogenated cocoate, C12 ethoxylates (Alfonic 1012-6, Hetoxol LA7, Hetoxol LA4), sodium alkyl benzene sulfonates (e.g., Nacconol 90G), and combinations and mixtures thereof. Anionic surfactants include but are not limited to linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap. Nonionic surfactants include but are not limited to alcohol ethoxylate (AEO or AE), carboxylated alcohol ethoxylates, nonylphenol ethoxylate, alkylpolyglycoside, alkyldimethylamine oxide, ethoxylated fatty acid monoethanolamide, fatty acid monoethanolamide, polyhydroxy alkyl fatty acid amide (e.g., as described in WO92/06154), polyoxyethylene esters of fatty acids, polyoxyethylene sorbitan esters (e.g., TWEENs), polyoxyethylene alcohols, polyoxyethylene isoalcohols, polyoxyethylene ethers (e.g., TRITONs and BRIJ), polyoxyethylene esters, polyoxyethylene-p-tert-octylphenols or octylphenyl-ethylene oxide condensates (e.g., NONIDET P40), ethylene oxide condensates with fatty alcohols (e.g., LUBROL), polyoxyethylene nonylphenols, polyalkylene glycols (SYNPERONIC F108), sugar-based surfactants (e.g., glycopyranosides, thioglycopyranosides), and combinations and mixtures thereof.

In a further embodiment, the laundry detergent compositions described herein further comprise a surfactant mixture that includes, but is not limited to 5-15% anionic surfactants, <5% nonionic surfactants, cationic surfactants, phosphonates, soap, enzymes, perfume, butylphenyl methylpropionate, geraniol, zeolite, polycarboxylates, hexyl cinnamal, limonene, cationic surfactants, citronellol, and benzisothiazolinone.

The laundry detergent compositions described herein may additionally include one or more detergent builders or builder systems, a complexing agent, a polymer, a bleaching system, a stabilizer, a foam booster, a suds suppressor, an anti-corrosion agent, a soil-suspending agent, an anti-soil redeposition agent, a dye, a bactericide, a hydrotope, an optical brightener, a fabric conditioner, and a perfume. The laundry detergent compositions described herein may also include additional enzymes selected from proteases, amylases, cellulases, lipases, mannanases, nucleases, pectinases, xyloglucanases, or perhydrolases, as provided in more detail herein.

In some embodiments, the laundry detergent compositions described herein further comprises from about 1%, from about 3% to about 60% or even from about 5% to about 40% builder by weight of the cleaning composition. Builders may include, but are not limited to, the alkali metals, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metals, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

In some embodiments, the builders form water-soluble hardness ion complexes (e.g., sequestering builders), such as citrates and polyphosphates (e.g., sodium tripolyphosphate and sodium tripolyphospate hexahydrate, potassium tripolyphosphate, and mixed sodium and potassium tripolyphosphate, etc.). Any suitable builder can find use in the compositions described herein, including those known in the art.

In some embodiments, the laundry detergent compositions described herein further comprise an adjunct ingredient including, but not limited to surfactants, builders, bleaches, bleach activators, bleach catalysts, additional enzymes, an enzyme stabilizer (including, for example, an enzyme stabilizing system), chelants, optical brighteners, soil release polymers, dye transfer agents, dye transfer inhibiting agents, catalytic materials, hydrogen peroxide, sources of hydrogen peroxide, preformed peracids, polymeric dispersing agents, clay soil removal agents, structure elasticizing agents, dispersants, suds suppressors, dyes, perfumes, colorants, filler salts, hydrotropes, photoactivators, fluorescers, fabric conditioners, hydrolyzable surfactants, solvents, preservatives, anti-oxidants, anti-shrinkage agents, anti-wrinkle agents, germicides, fungicides, color speckles, anti-corrosion agents, alkalinity sources, solubilizing agents, carriers, processing aids, pigments, pH control agents, and combinations thereof. (See, e.g., U.S. Pat. Nos. 6,610,642, 6,605,458, 5,705,464, 5,710,115, 5,698,504, 5,695,679, 5,686,014, and 5,646,101). In some embodiments, one or more adjunct is incorporated for example, to assist or enhance cleaning performance, for treatment of the substrate to be cleaned, or to modify the aesthetics of the cleaning composition as is the case with perfumes, colorants, dyes or the like. Any such adjunct ingredient is in addition to the low temperature mannanase, low temperature amylase, and/or low temperature protease described herein. In some embodiments, the adjunct ingredient is selected from surfactants, enzyme stabilizers, builder compounds, polymeric compounds, bleaching agents, additional enzymes, suds suppressors, dispersants, lime-soap dispersants, soil suspension agents, softening agents, anti-redeposition agents, corrosion inhibitors, and combinations thereof.

In some further embodiments, the laundry detergent compositions described herein comprise one or more enzyme stabilizer. In some embodiments, the enzyme stabilizer is a water-soluble source of calcium and/or magnesium ions. In some embodiments, the enzyme stabilizers include oligosaccharides, polysaccharides, and inorganic divalent metal salts, including alkaline earth metals, such as calcium salts. In some embodiments, the enzymes employed herein are stabilized by the presence of water-soluble sources of zinc (II), calcium (II) and/or magnesium (II) ions in the finished compositions that provide such ions to the enzymes, as well as other metal ions (e.g., barium (II), scandium (II), iron (II), manganese (II), aluminum (III), tin (II), cobalt (II), copper (II), nickel (II), and oxovanadium (IV)). Chlorides and sulfates also find use in some embodiments. Exemplary oligosaccharides and polysaccharides (e.g., dextrins) are described, for example, in WO07145964. In some embodiments, the laundry detergent compositions described herein contain reversible protease inhibitors selected from a boron-containing compound (e.g., borate, 4-formyl phenyl boronic acid, and phenyl-boronic acid derivatives, such as, e.g., are described in WO9641859); a peptide aldehyde (such as, e.g., is described in WO2009118375 and WO2013004636), and combinations thereof.

The cleaning compositions herein are typically formulated such that, during use in aqueous cleaning operations, the wash water will have a pH of from about 3.0 to about 11. Liquid product formulations are typically formulated to have a neat pH from about 5.0 to about 9.0, more preferably from about 7.5 to about 9. Granular laundry products are typically formulated to have a pH from about 8.0 to about 11.0. Techniques for controlling pH at recommended usage levels include the use of buffers, alkalis, acids, etc., and are well known to those skilled in the art.

Suitable high pH cleaning compositions typically have a neat pH of from about 9.0 to about 11.0, or even a neat pH of from 9.5 to 10.5. Such cleaning compositions typically comprise a sufficient amount of a pH modifier, such as sodium hydroxide, monoethanolamine, or hydrochloric acid, to provide such cleaning composition with a neat pH of from about 9.0 to about 11.0. Such compositions typically comprise at least one base-stable enzyme. In some embodiments, the compositions are liquids, while in other embodiments, they are solids.

In one embodiment, the cleaning compositions include those having a pH of from 7.4 to pH 11.5, or pH 7.4 to pH 11.0, or pH 7.5 to pH 11.5, or pH 7.5 to pH 11.0, or pH 7.5 to pH 10.5, or pH 7.5 to pH 10.0, or pH 7.5 to pH 9.5, or pH 7.5 to pH 9.0, or pH 7.5 to pH 8.5, or pH 7.5 to pH 8.0, or pH 7.6 to pH 11.5, or pH 7.6 to pH 11.0, or pH 7.6 to pH 10.5, or pH 8.7 to pH 10.0, or pH 8.0 to pH 11.5, or pH 8.0 to pH 11.0, or pH 8.0 to pH 10.5, or pH 8.0 to pH 10.0.

Concentrations of detergent compositions in typical wash solutions throughout the world vary from less than about 800 ppm of detergent composition (“low detergent concentration geographies”), for example about 667 ppm in Japan, to between about 800 ppm to about 2000 ppm (“medium detergent concentration geographies”), for example about 975 ppm in U.S. and about 1500 ppm in Brazil, to greater than about 2000 ppm (“high detergent concentration geographies”), for example about 4500 ppm to about 5000 ppm in Europe and about 6000 ppm in high suds phosphate builder geographies.

In some embodiments, the detergent compositions described herein may be utilized at a temperature of from about 10° C. to about 60° C., or from about 20° C. to about 60° C., or from about 30° C. to about 60° C., from about 40° C. to about 60° C., from about 40° C. to about 55° C., or all ranges within 10° C. to 60° C. In some embodiments, the detergent compositions described herein are used in “cold water washing” at temperatures of from about 10° C. to about 40° C., or from about 20° C. to about 30° C., from about 15° C. to about 25° C., from about 15° C. to about 35° C., or all ranges within 10° C. to 40° C.

As a further example, different geographies typically have different water hardness. Water hardness is usually described in terms of the grains per gallon mixed Ca²⁺/Mg²⁺. Hardness is a measure of the amount of calcium (Ca²⁺) and magnesium (Mg²⁺) in the water. Most water in the United States is hard, but the degree of hardness varies. Moderately hard (60-120 ppm) to hard (121-181 ppm) water has 60 to 181 parts per million (parts per million converted to grains per U.S. gallon is ppm #divided by 17.1 equals grains per gallon) of hardness minerals.

TABLE 1
Water Hardness Levels

| Water | Grains per gallon | Parts per million |
|---|---|---|
| Soft | less than 1.0 | less than 17 |
| Slightly hard | 1.0 to 3.5 | 17 to 60 |
| Moderately hard | 3.5 to 7.0 | 60 to 120 |
| Hard | 7.0 to 10.5 | 120 to 180 |
| Very hard | greater than 10.5 | greater than 180 |

European water hardness is typically greater than about 10.5 (for example about 10.5 to about 20.0) grains per gallon mixed Ca²⁺/Mg²⁺ (e.g., about 15 grains per gallon mixed Ca²⁺/Mg²⁺), North American water hardness is typically greater than Japanese water hardness, but less than European water hardness. For example, North American water hardness can be between about 3 to about 10 grains, about 3 to about 8 grains or about 6 grains. Japanese water hardness is typically lower than North American water hardness, usually less than about 4, for example about 3 grains per gallon mixed Ca²⁺/Mg²⁺.

In other embodiments, the composition described herein comprises one or more additional enzyme. The one or more additional enzyme is selected from acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, DNases, endo-beta-1, 4-glucanases, endo-beta-mannanases, esterases, exo-mannanases, galactanases, glucoamylases, hexosaminidases, hemicellulases, hyaluronidases, keratinases, laccases, lactases, ligninases, lipases, lipoxygenases, lysozymes, mannanases, additional metalloproteases, nucleases (e.g. deoxyribonucleases and ribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof. Some embodiments are directed to a combination of enzymes (i.e., a “cocktail”) comprising enzymes like amylase, protease, lipase, mannanase, and/or nuclease in conjunction with one or more thermolysin polypeptides in the compositions provided herein.

In some embodiments, the compositions provided herein comprise a polypeptide having thermolysin activity in combination with a protease. The protease for use in combination with the thermolysin in the compositions of the instant disclosure include any polypeptide having protease activity. In one embodiment, the additional protease is a serine protease. In another embodiment, the additional protease is an additional metalloprotease, a fungal subtilisin, or an alkaline microbial protease or a trypsin-like protease. Suitable additional proteases include those of animal, vegetable or microbial origin. In some embodiments, the protease is a microbial protease. In other embodiments, the protease is a chemically or genetically modified mutant. In another embodiment, the protease is subtilisin like protease or a trypsin-like protease. In other embodiments, the additional protease does not contain cross-reactive epitopes with the variant as measured by antibody binding or other assays available in the art. Exemplary subtilisin proteases include those derived from for example, Bacillus (e.g., e.g., BPN′, Carlsberg, subtilisin 309, subtilisin 147, and subtilisin 168), or fungal origin, such as, for example, those described in U.S. Pat. No. 8,362,222. Exemplary additional proteases include but are not limited to those described in WO92/21760, WO95/23221, WO2008/010925, WO09/149200, WO09/149144, WO09/149145, WO 10/056640, WO10/056653, WO2010/0566356, WO11/072099, WO2011/13022, WO11/140364, WO 12/151534, WO2015/038792, WO2015/089447, WO2015/089441, WO 2017/215925, US Publ. No. 2008/0090747, U.S. Pat. Nos. 5,801,039, 5,340,735, 5,500,364, 5,855,625, RE 34,606, U.S. Pat. Nos. 5,955,340, 5,700,676 6,312,936, 6,482,628, 8,530,219, U.S. Provisional Appl Nos. 62/180,673 and 62/161,077, and PCT Appl Nos. PCT/US2015/021813, PCT/US2015/055900, PCT/US2015/057497, PCT/US2015/057492, PCT/US2015/057512, PCT/US2015/057526, PCT/US2015/057520, PCT/US2015/057502, PCT/US2016/022282, and PCT/US16/32514, International publications WO2016001449, WO2016087617, WO2016096714, WO2016203064, WO2017089093, and WO2019180111, as well as metalloproteases described in WO1999014341, WO1999033960, WO1999014342, WO1999034003, WO2007044993, WO2009058303, WO 2009058661, WO2014071410, WO2014194032, WO2014194034, WO 2014194054, and WO 2014/194117. Exemplary additional proteases include, but are not limited to trypsin (e.g., of porcine or bovine origin) and the Fusarium protease described in WO89/06270. Exemplary commercial proteases include, but are not limited to MAXATASE®, MAXACAL™, MAXAPEM™, OPTICLEAN®, OPTIMASE®, PROPERASE®, PURAFECT®, PURAFECT® OXP, PURAMAX™, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (DuPont); ALCALASE®, BLAZE®, BLAZE® variants, BLAZER EVITY®, BLAZER EVITY® 16L, CORONASE®, SAVINASE®, SAVINASE® ULTRA, SAVINASE® EVITY®, SAVINASE® EVERIS®, PRIMASE®, DURAZYM™, POLARZYME®, OVOZYME®, KANNASE®, LIQUANASE®, LIQUANASE EVERIS®, NEUTRASE®, PROGRESS UNO®, RELASE®, and ESPERASE® (Novozymes); BLAP™ and BLAP™ variants (Henkel); LAVERGY™ PRO 104 L (BASF), KAP (B. alkalophilus subtilisin (Kao)) and BIOTOUCH® (AB Enzymes).

In some embodiments, the compositions provided herein comprise a polypeptide having thermolysin activity in combination with one or more amylases. In one embodiment, the composition comprises from about 0.00001% to about 10%, about 0.0001% to about 10%, about 0.001% to about 5%, about 0.001% to about 2%, or about 0.005% to about 0.5% amylase by weight composition. Any amylase (e.g., alpha and/or beta) suitable for use in alkaline solutions may be useful to include in such composition. An exemplary amylase can be a chemically or genetically modified mutant. Exemplary amylases include, but are not limited to those of bacterial or fungal origin, such as, for example, amylases described in GB 1,296,839, WO9100353, WO9402597, WO94183314, WO9510603, WO9526397, WO9535382, WO9605295, WO9623873, WO9623874, WO 9630481, WO9710342, WO9741213, WO9743424, WO9813481, WO 9826078, WO9902702, WO 9909183, WO9919467, WO9923211, WO9929876, WO9942567, WO 9943793, WO9943794, WO 9946399, WO0029560, WO0060058, WO0060059, WO0060060, WO 0114532, WO0134784, WO 0164852, WO0166712, WO0188107, WO0196537, WO02092797, WO 0210355, WO0231124, WO 2004055178, WO2004113551, WO2005001064, WO2005003311, WO 2005018336, WO2005019443, WO2005066338, WO2006002643, WO2006012899, WO2006012902, WO2006031554, WO 2006063594, WO2006066594, WO2006066596, WO2006136161, WO 2008000825, WO2008088493, WO2008092919, WO2008101894, WO2008/112459, WO2009061380, WO2009061381, WO 2009100102, WO2009140504, WO2009149419, WO 2010/059413, WO 2010088447, WO2010091221, WO2010104675, WO2010115021, WO10115028, WO2010117511, WO 2011076123, WO2011076897, WO2011080352, WO2011080353, WO 2011080354, WO2011082425, WO2011082429, WO 2011087836, WO2011098531, WO2013063460, WO2013184577, WO 2014099523, WO2014164777, and WO2015077126. Exemplary commercial amylases include, but are not limited to AMPLIFY®, DURAMYL®, TERMAMYL®, FUNGAMYL®, STAINZYME®, STAINZYME PLUS®, STAINZYME PLUS®, STAINZYME ULTRA® EVITY®, and BAN™ (Novozymes); EFFECTENZ™ S 1000, POWERASE™, PREFERENZ™ S 100, PREFERENZ™ S 110, EXCELLENZ™ S 2000, RAPIDASE® and MAXAMYL® P (DuPont).

In some embodiments, the compositions provided herein comprise a polypeptide having thermolysin activity in combination with one or more lipases. In some embodiments, the composition comprises from about 0.00001% to about 10%, about 0.0001% to about 10%, about 0.001% to about 5%, about 0.001% to about 2%, or about 0.005% to about 0.5% lipase by weight composition. An exemplary lipase can be a chemically or genetically modified mutant. Exemplary lipases include, but are not limited to, e.g., those of bacterial or fungal origin, such as, e.g., H. lanuginosa lipase (see, e.g., EP 258068 and EP 305216), T. lanuginosa lipase (see, e.g., WO 2014/059360 and WO2015/010009), Rhizomucor miehei lipase (see, e.g., EP 238023), Candida lipase, such as C. antarctica lipase (e.g., C. antarctica lipase A or B) (see, e.g., EP 214761), Pseudomonas lipases such as P. alcaligenes and P. pseudoalcaligenes lipase (see, e.g., EP 218272), P. cepacia lipase (see, e.g., EP 331376), P. stutzeri lipase (see, e.g., GB 1,372,034), P. fluorescens lipase, Bacillus lipase (e.g., B. subtilis lipase (Dartois et al., Biochem. Biophys. Acta 1131:253-260 (1993)), B. stearothermophilus lipase (see, e.g., JP 64/744992), and B. pumilus lipase (see, e.g., WO 91/16422)). Exemplary cloned lipases include, but are not limited to Penicillium camembertii lipase (See, Yamaguchi et al., Gene 103:61-67 (1991)), Geotrichum candidum lipase (See, Schimada et al., J. Biochem., 106:383-388 (1989)), and various Rhizopus lipases, such as, R. delemar lipase (See, Hass et al., Gene 109:117-113 (1991)), R. niveus lipase (Kugimiya et al., Biosci. Biotech. Biochem. 56:716-719 (1992)) and R. oryzae lipase. Other lipolytic enzymes, such as cutinases, may also find use in one or more composition described herein, including, but not limited to, e.g., cutinase derived from Pseudomonas mendocina (see, WO 88/09367) and/or Fusarium solani pisi (see, WO90/09446). Exemplary commercial lipases include, but are not limited to M1 LIPASE™, LUMA FAST™, and LIPOMAX™ (DuPont); LIPEX®, LIPOCLEAN®, LIPOLASE® and LIPOLASE® ULTRA (Novozymes); and LIPASE P™ (Amano Pharmaceutical Co. Ltd).

In some embodiments, the compositions provided herein comprise a polypeptide having thermolysin activity in combination with one or more mannanases. In one embodiment, the composition comprises from about 0.00001% to about 10%, about 0.0001% to about 10%, about 0.001% to about 5%, about 0.001% to about 2%, or about 0.005% to about 0.5% mannanase by weight composition. An exemplary mannanase can be a chemically or genetically modified mutant. Exemplary mannanases include, but are not limited to, those of bacterial or fungal origin, such as, for example, those described in WO 2016/007929; U.S. Pat. Nos. 6,566,114; 6,602,842; and 6,440,991; and U.S. Provisional Appl. Nos. 62/251,516, 62/278,383, and 62/278,387. Exemplary commercial mannanases include, but are not limited to MANNAWAY® (Novozymes) and EFFECTENZ™ M 1000, EFFECTENZ™ M 2000, PREFERENZ® M 100, MANNASTAR®, and PURABRITE™ (DuPont).

In some embodiments, the compositions and methods provided herein comprise a polypeptide having thermolysin activity and a perfume in combination with a nuclease, such as a DNase or RNase. Exemplary nucleases include, but are not limited to, those described in WO2015181287, WO2015155350, WO2016162556, WO2017162836, WO2017060475 (e.g. SEQ ID NO: 21), WO2018184816, WO2018177936, WO2018177938, WO2018/185269, WO2018185285, WO2018177203, WO2018184817, WO2019084349, WO2019084350, WO2019081721, WO2018076800, WO2018185267, WO2018185280, and WO2018206553. Other nucleases which can be used in combination with the polypeptides having thermolysin activity and a perfume in the compositions and methods provided herein include those described in Nijland R, Hall M J, Burgess J G (2010) Dispersal of Biofilms by Secreted, Matrix Degrading, Bacterial DNase. PLoS ONE 5 (12) and Whitchurch, C. B., Tolker-Nielsen, T., Ragas, P. C., Mattick, J. S. (2002) Extracellular DNA required for bacterial biofilm formation. Science 295:1487.

Yet a still further embodiment is directed to a composition comprising one or more thermolysins described herein, a perfume, and one or more cellulase. In one embodiment, the composition comprises from about 0.00001% to about 10%, 0.0001% to about 10%, about 0.001% to about 5%, about 0.001% to about 2%, or about 0.005% to about 0.5% cellulase by weight of composition. Any suitable cellulase may find use in a composition described herein. An exemplary cellulase can be a chemically or genetically modified mutant. Exemplary cellulases include but are not limited, to those of bacterial or fungal origin, such as, for example, those described in WO2005054475, WO2005056787, U.S. Pat. Nos. 7,449,318, 7,833,773, 4,435,307; EP 0495257; and U.S. Provisional Appl. No. 62/296,678. Exemplary commercial cellulases include, but are not limited to, CELLUCLEAN®, CELLUZYME®, CAREZYME®, ENDOLASE®, RENOZYME®, and CAREZYME® PREMIUM (Novozymes); REVITALENZ™ 100, REVITALENZ™ 200/220, and REVITALENZ® 2000 (DuPont); and KAC-500 (B)™ (Kao Corporation). In some embodiments, cellulases are incorporated as portions or fragments of mature wild-type or variant cellulases, wherein a portion of the N-terminus is deleted (see, e.g., U.S. Pat. No. 5,874,276).

In some embodiments, the laundry detergent compositions described herein comprise at least one chelating agent. Suitable chelating agents may include, but are not limited to copper, iron, and/or manganese chelating agents, and mixtures thereof. In some embodiments, the laundry detergent compositions described herein comprises from about 0.1% to about 15% or even from about 3.0% to about 10% chelating agent by weight of composition.

In some still further embodiments, the laundry detergent compositions described herein comprise at least one deposition aid. Suitable deposition aids include, but are not limited to, polyethylene glycol, polypropylene glycol, polycarboxylate, soil release polymers such as polyterephthalic acid, clays such as kaolinite, montmorillonite, attapulgite, illite, bentonite, halloysite, and mixtures thereof.

In some embodiments, the laundry detergent compositions described herein comprise at least one anti-redeposition agent.

In some embodiments, the laundry detergent compositions described herein comprise one or more dye transfer inhibiting agent. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones, and polyvinylimidazoles, or mixtures thereof. In some embodiments, the laundry detergent compositions described herein comprise from about 0.0001% to about 10%, from about 0.01% to about 5%, or even from about 0.1% to about 3% dye transfer inhibiting agent by weight of composition.

In some embodiments, the laundry detergent compositions described herein comprise one or more silicates. In some such embodiments, sodium silicates (e.g., sodium disilicate, sodium metasilicate, and crystalline phyllosilicates) find use. In some embodiments, the laundry detergent compositions described herein comprise from about 1% to about 20% or from about 5% to about 15% silicate by weight of the composition.

In yet further embodiments, the laundry detergent compositions described herein comprise one or more dispersant. Suitable water-soluble organic materials include, but are not limited to the homo- or co-polymeric acids or their salts, in which the polycarboxylic acid comprises at least two carboxyl radicals separated from each other by not more than two carbon atoms.

In some embodiments, the laundry detergent compositions described herein comprise one or more bleach, bleach activator, and/or bleach catalyst. In some embodiments, the laundry detergent compositions described herein comprise inorganic and/or organic bleaching compound(s). Inorganic bleaches may include, but are not limited to perhydrate salts (e.g., perborate, percarbonate, perphosphate, persulfate, and persilicate salts). In some embodiments, inorganic perhydrate salts are alkali metal salts. In some embodiments, inorganic perhydrate salts are included as the crystalline solid, without additional protection, although in some other embodiments, the salt is coated. Suitable salts include, for example, those described in EP2100949. Bleach activators are typically organic peracid precursors that enhance the bleaching action in the course of cleaning at temperatures of 60° C. and below. Bleach activators suitable for use herein include compounds which, under perhydrolysis conditions, give aliphatic peroxycarboxylic acids having preferably from about 1 to about 10 carbon atoms, in particular from about 2 to about 4 carbon atoms, and/or optionally substituted perbenzoic acid. Bleach catalysts typically include, for example, manganese triazacyclononane and related complexes, and cobalt, copper, manganese, and iron complexes, as well as those described in U.S. Pat. Nos. 4,246,612, 5,227,084, 4,810,410, WO9906521, and EP2100949.

In some embodiments, the laundry detergent compositions described herein comprise one or more catalytic metal complex. In some embodiments, a metal-containing bleach catalyst finds use. In other embodiments, the metal bleach catalyst comprises a catalyst system comprising a transition metal cation of defined bleach catalytic activity (e.g., copper, iron, titanium, ruthenium, tungsten, molybdenum, or manganese cations), an auxiliary metal cation having little or no bleach catalytic activity (e.g., zinc or aluminum cations), and a sequestrate having defined stability constants for the catalytic and auxiliary metal cations, particularly ethylenediaminetetraacetic acid, ethylenediaminetetra (methylenephosphonic acid) and water-soluble salts thereof are used (See, e.g., U.S. Pat. No. 4,430,243). In some embodiments, the laundry detergent compositions described herein are catalyzed by means of a manganese compound. Such compounds and levels of use are well known in the art (See, e.g., U.S. Pat. No. 5,576,282). In additional embodiments, cobalt bleach catalysts find use in the laundry detergent compositions described herein. Various cobalt bleach catalysts are known in the art (See, e.g., U.S. Pat. Nos. 5,597,936 and 5,595,967) and are readily prepared by known procedures.

Some embodiments are directed to a method of cleaning comprising contacting an effective amount of a cleaning composition described herein with an item or surface comprising a soil, stain or malodor to hydrolyze the soil, stain or malodor.

Other aspects and embodiments of the present compositions and methods will be apparent from the foregoing description and following examples. Various alternative embodiments beyond those described herein can be employed in practicing the invention without departing from the spirit and scope of the invention. Accordingly, the claims, and not the specific embodiments described herein, define the scope of the invention and as such methods and structures within the scope of the claims and their equivalents are covered thereby.

### EXAMPLES

### Example 1. Treatment of Laundry Malodor

Laundry malodor was developed in situ in a Launder-Ometer washing machine model system as follows. Tryptic soy broth (TSB) was inoculated with Staphylococcus epidermidis (ATCC 35984) and the culture was grown at 30 degrees Celsius and 250 RPM overnight in an incubator-shaker. The OD600 of the overnight culture was determined. With the resulting OD600 value, a solution of tryptic soy broth (TSB) and overnight culture was made such that the final cell suspension measured approximately 0.10-0.15 OD600 with a spectrophotometer, with media background subtracted. This cell suspension (75 mL per dish) was added to polystyrene petri dishes (VWR 25384-088) containing an autoclaved stainless steel plate designed for insertion into Launder-Ometer pots (AATCC SDL Atlas). The petri dishes with stainless steel plates were incubated at 30 degrees Celsius without agitation for 48 hours. After incubation, the liquid cell culture was discarded and the stainless steel plates were briefly allowed to dry in a laminar flow hood (~25 minutes). The coated stainless steel plates were then placed in a fresh sterile petri dish, rinsed with sterile PBS buffer, and then allowed to dry briefly again (~25 minutes). The coated Launder-Ometer plates were then placed into Launder-Ometer pots. In each Launder-Ometer pot, one coated plate and two uncoated, autoclaved stainless steel plates were placed, such that the three plates form an equilateral triangle. In all cases, the odor-producing microbial residue faced outward, away from the center of the triangle, to mimic the outside of the washer drum and other washing machine surfaces not visible to the consumer that can remain coated with malodor-causing residues. A plastic bottle cap (Nalgene) sized appropriately was placed inside the equilateral triangle to hold the stainless steel plates immobile inside the Launder-Ometer pot-Three sheets of autoclaved polyester ballast fabric (Testfabrics Inc. Style 730: Texturized Dacron 56T interlock Knit, 8×12 cm pieces) were placed inside the equilateral triangle inside the Launder-Ometer pot.

The Launder-Ometer pots were then subjected to simulated laundry washes. To each pot, 200 mL of wash liquor was added. Wash liquors were made as follows. All pots contained a solution of deionized water with added hardness to reach 16° dH hardness (3:1 Ca:Mg) as well as 0.4 g/L of Tide Original liquid detergent (Procter & Gamble). The “detergent only” wash solution contained no additional ingredients. The “+fragrance” and “+enzyme+fragrance” wash solutions additionally contained a 0.001% solution of a fragrance mixture (Skydive Mod, IFF). The “+enzyme” and “+enzyme+fragrance” wash solutions additionally contained thermolysin enzyme (Proteinase T, IFF) at a dosage of 80 PPM. All washes were carried out in the Launder-Ometer set to 25 degrees. Each pot was subjected to a 25 minute wash in the Launder-Ometer. Following the first wash, the wash liquor was poured off and replaced with a fresh wash solution of the same composition used in the first wash. Each pot was then subjected to a second 25 minute wash cycle in the Launder-Ometer. Following the two washes, all pots were rinsed for 10 minutes in the Launder-Ometer with a rinse solution of 200 mL DI water with 16° dH hardness (3:1 Ca:Mg). The final rinse solution was poured off.

A synthetic sweat solution (200 mL) to promote odor development was added to each Launder-Ometer pot (Table 2).

TABLE 2
Components of a synthetic sweat solution

| | Weight % |
|---|---|
| Component | (in water) |
| Glucose | 1% |
| Sodium Chloride | 0.5% |
| Disodium hydrogen orthophosphate | 0.5% |
| dodecahydrate | |
| Leucine | 0.2% |
| Casamino acids | 0.1% |
| L-Histidine | 0.05% |
| Potassium phosphate dibasic | 2.52 × 10⁻⁴% |
| Ammonium nitrate | 3.6 × 10⁻⁴% |
| Ferrous sulfate | 7.2 × 10⁻⁷% |
| Magnesium sulfate | 2.52 × 10⁻⁴% |
| Potassium phosphate monobasic | 2.52 × 10⁻⁴% |
| Zinc sulfate | 7.2 × 10⁻⁷% |

The Launder-Ometer pots were sealed, rotated several times to mix, and then incubated at 30 degrees Celsius for 4 days with no agitation. The odor in the Launder-Ometer pots after 4 days was evaluated by an odor sensory panel of 11 participants. The odor panel members were asked to lift the lids of the Launder-Ometer pots and evaluate the odor of each pot on a scale from 1 (“smells bad”) to 5 (“smells good”). Results are shown in Table 3.

TABLE 3
Odor panel evaluation of laundry malodor samples.

| | Odor panel |
|---|---|
| Condition | score (n = 11) |
| Detergent only | 1.7 ± 0.6 |
| Enzyme | 3.1 ± 0.3 |
| Fragrance | 2.5 ± 1.1 |
| Enzyme + Fragrance | 4.6 ± 0.5 |

As seen in Table 3, the enzyme-fragrance mixture showed a substantial improvement in odor, far beyond the error in the experiment, and far beyond either enzyme or fragrance alone. The benefit of the combination of enzyme and fragrance was larger than would be expected for the sum of the individual effects for enzyme and fragrance. For example, the benefit provided by the fragrance relative to detergent alone (the odor panel score for detergent+fragrance minus that of the detergent alone) was 0.8, while the benefit provided by detergent+enzyme alone was 1.4. The expected benefit of the combination of enzyme and fragrance would thus be expected to be around 2.2 (the sum of the individual benefits for enzyme and fragrance). However, the observed benefit of the enzyme fragrance combination (odor panel score for the combination minus that of the detergent alone) was 2.9, larger than the value predicted by simple additivity of the individual effects. Three odor sensory panel participants scored the fragrance-containing sample as favorable with score of greater than 4.0 or greater and only one participant scored the enzyme-containing sample as favorable with a score of 4.0 or greater. However, all 11 participants scored the enzyme-fragrance conformation as favorable with a score of 4.0 or greater. Without being limited to a theory, the cleaning of odor-causing residues by the enzyme may reduce the experience of mixed odors (that leads to a wide response and high standard deviation in panel response with fragrance in the absence of enzyme), leading to a greater and more uniform favorable response in the combination than expected from the individual effects.

### Example 2. Treatment of Laundry Malodor

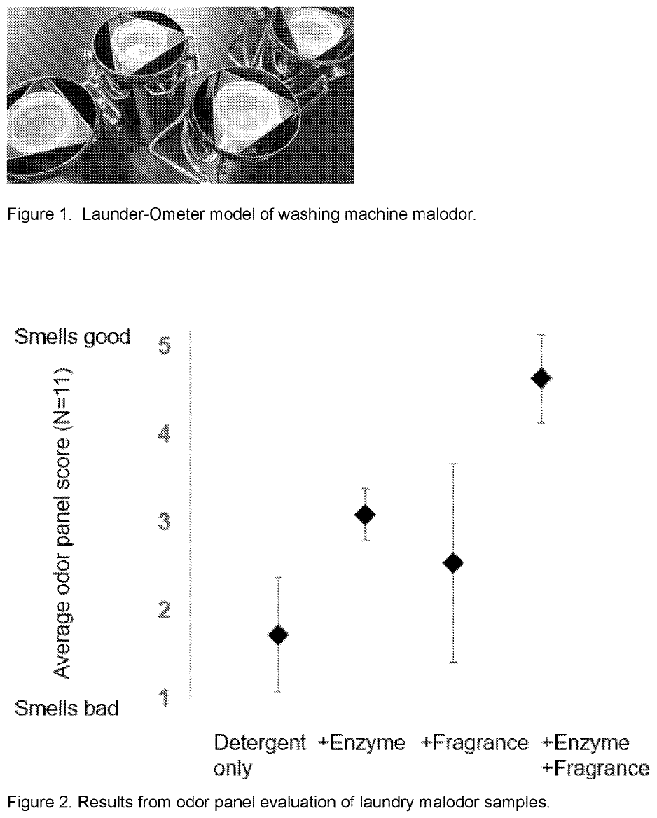

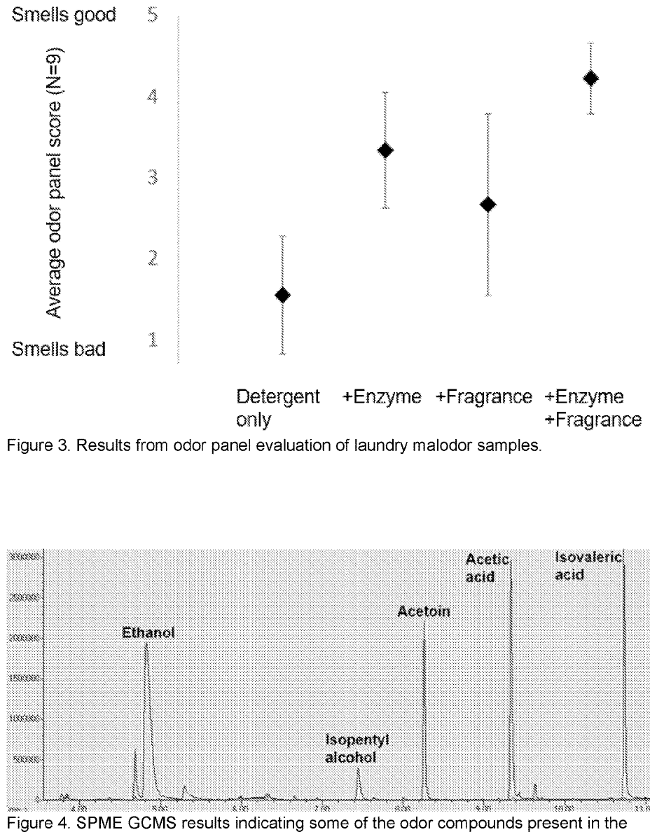

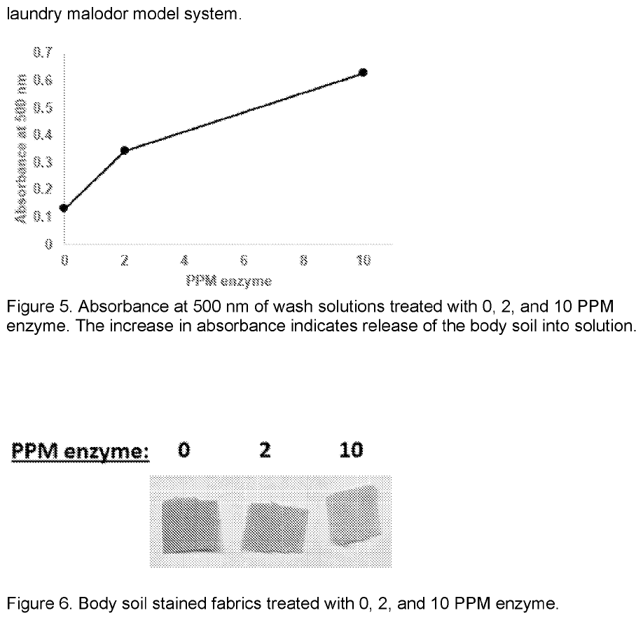

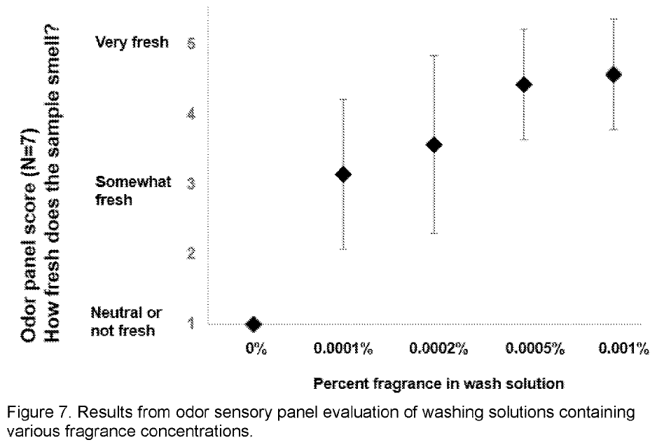

Laundry malodor was developed in situ in a Launder-Ometer washing machine model system as follows. Tryptic soy broth (TSB) was inoculated with Staphylococcus epidermidis (ATCC 35984) and the culture was grown at 30 degrees Celsius and 250 RPM overnight in an incubator-shaker. The OD600 of the overnight culture was determined. With the resulting OD600 value, a solution of tryptic soy broth (TSB) and overnight culture was made such that the final cell suspension measured approximately 0.10-0.15 OD600 with a spectrophotometer, with media background subtracted. This cell suspension (75 mL per dish) was added to polystyrene petri dishes (VWR 25384-088) containing an autoclaved stainless steel plate designed for insertion into Launder-Ometer pots (AATCC SDL Atlas). The petri dishes with stainless steel plates were incubated at 30 degrees Celsius without agitation for 48 hours. After incubation, the liquid cell culture was discarded and the stainless steel plates were briefly allowed to dry in a laminar flow hood (~25 minutes). The coated stainless steel plates were then placed in a fresh sterile petri dish, rinsed with sterile PBS buffer, and then allowed to dry briefly again (~25 minutes). The coated Launder-Ometer plates were then placed into Launder-Ometer pots. In each Launder-Ometer pot, one coated plate and two uncoated, autoclaved stainless steel plates were placed, such that the three plates form an equilateral triangle. In all cases, the odor-producing microbial residue faced outward, away from the center of the triangle, to mimic the outside of the washer drum and other washing machine surfaces not visible to the consumer that can remain coated with malodor-causing residues. A plastic bottle cap (Nalgene) sized appropriately was placed inside the equilateral triangle to hold the stainless steel plates immobile inside the Launder-Ometer pot (FIG. 1). Three sheets of autoclaved polyester ballast fabric (Testfabrics Inc. Style 730: Texturized Dacron 56T interlock Knit, 8×12 cm pieces) were placed inside the equilateral triangle inside the Launder-Ometer pot.

The Launder-Ometer pots were then subjected to simulated laundry washes. To each pot, 200 mL of wash liquor was added. Wash liquors were made as follows. All pots contained a solution of deionized water with added hardness to reach 100 PPM water hardness (3:1 Ca:Mg) as well as 0.5 g/L of Tide Original liquid detergent (Procter & Gamble). The “detergent only” wash solution contained no additional ingredients. The “+fragrance” and “+enzyme+fragrance” wash solutions additionally contained a 0.001% solution of a fragrance mixture (Skydive Mod, IFF). The “+enzyme” and “+enzyme+fragrance” wash solutions additionally contained thermolysin enzyme (Proteinase T, IFF) at a dosage of 80 PPM. All washes were carried out in the Launder-Ometer set to 25 degrees. Each pot was subjected to a 35 minute first wash cycle in the Launder-Ometer. Following the first wash, the wash liquor in each pot was poured off and replaced with a rinse solution of 200 mL DI water with 100 PPM water hardness (3:1 Ca:Mg). Each pot was subjected to an 8 minute first rinse cycle in the Launder-Ometer. Following the rinse cycle, the rinse solution was poured off and replaced with fresh wash solution of the same composition used in the first wash. Each pot was then subjected to a 35 minute second wash cycle in the Launder-Ometer. Following the second wash, the wash solution was poured off and replaced with fresh rinse solution, and then the pots were rinsed in a second 8 minute Launder-Ometer rinse cycle. The final rinse solution was poured off.

A synthetic sweat solution (200 mL), as described in Example 1, was added to each Launder-Ometer pot to promote odor development.

The Launder-Ometer pots were sealed, rotated several times to mix, and then incubated at 30 degrees Celsius for 4 days with no agitation. The odor in the Launder-Ometer pots after 4 days was evaluated by an odor sensory panel of 9 participants. The odor panel was asked to lift the lids of the Launder-Ometer pots and evaluate the odor of each pot on a scale from 1 (“smells bad”) to 5 (“smells good”). Results are shown in Table 4.

TABLE 4
Odor panel evaluation of laundry malodor samples.

| | Odor panel |
|---|---|
| Condition | score (n = 9) |
| Detergent only | 1.6 ± 0.7 |
| Enzyme | 3.3 ± 0.7 |
| Fragrance | 2.7 ± 1.1 |
| Enzyme + | 4.2 ± 0.4 |
| Fragrance | |

As seen in Table 4, the enzyme-fragrance mixture showed a substantial improvement in odor, far beyond the error in the experiment, and far beyond either enzyme or fragrance alone. As in Example 1, the benefit of the combination of enzyme and fragrance was larger than would be expected for the sum of the individual effects for enzyme and fragrance. For example, the benefit provided by the fragrance relative to detergent alone (the odor panel score for detergent+fragrance minus that of the detergent alone) was 1.1, while the benefit provided by detergent+enzyme alone was 0.7. The expected benefit of the combination of enzyme and fragrance would thus be expected to be around 1.8 (the sum of the individual benefits for enzyme and fragrance). However, the observed benefit of the enzyme-fragrance combination (odor panel score for the combination minus that of the detergent alone) was 2.6, larger than the value predicted by simple additivity of the individual effects. In this experiment, three participants scored the fragrance-containing sample as favorable with score of greater than 4.0 or greater and two participants scored the enzyme-containing sample as favorable with a score of 4.0 or greater. However, all 9 participants scored the enzyme-fragrance conformation as favorable with a score of 4.0 or greater.

### Example 3. GC-MS Analysis of Malodor Compounds

The volatile odor compounds present in the Launder-Ometer odor system were analyzed as follows. Staphylococcus epidermidis cultures were grown for 48 hours in autoclaved 20 mL GC-MS vials (Agilent Technologies part number 5188-2753) following the same procedure as in Examples 1 and 2, with 4 mL of cell suspension in the GC-MS vials. After 48 hours, the residue coating the bottom of the vial was rinsed with PBS and then the PBS was removed. Then 4 mL of synthetic sweat solution, as in Example 1, was added to the vial and the vial was placed at 30 degrees C. for 4 days with the cap screwed on (cap is Agilent Technologies part number 5188-2759). Samples were analyzed with Agilent 7890/5975 GC-MS system with a CTC GC PAL autosampler in SPME mode, using splitless mode starting at 40 degrees Celsius and ramping up to 240 degrees Celsius. The column was Zebron ZB-FFAP (30 m×0.32 mm×0.5 μm). The SPME fiber used was a Supelco SPME fiber (blue tip-carboxen/PDMS 23 gauge). SPME GCMS results identified some of the odor compounds present in the laundry malodor model system such as ethanol, isopentyl alcohol, acetoin, acetic acid and isovaleric acid.

### Example 4. Cleaning of Odor-Producing Residues

To further evaluate enzymatic cleaning of odor-producing residues, enzymatic removal of body soil stains was tested. Soiled fabric, Consumertec Collar and Cuff dingy monitor DINGY_TN/CP/USA (Consumertec), was cut into small squares, about 0.5-0.6 cm on each side). The soiled fabric squares were placed into the wells of a 96-well plate and used in washing tests. In each well, a 250 microliter solution of 1:1200 diluted Tide Original liquid laundry detergent in water was added, along with thermolysin (Proteinase T, IFF) at 0, 2, or 10 PPM enzyme concentration. To simulate a wash cycle, the microplate was sealed and then placed into an iEMS incubator shaker set to 25 degrees for 30 minutes and 1150 rpm. Following the simulated wash cycle, 200 microliters of the liquid was removed to a fresh 96-well plate and the absorbance was read at 500 nm.

TABLE 5
Absorbance at 500 nm of wash solutions treated with
0, 2, and 10 PPM enzyme. The increase in absorbance
indicates release of the body soil into solution.

| PPM | Absorbance |
|---|---|
| enzyme | at 500 nm |
| 0 | 0.13 |
| 2 | 0.34 |
| 10 | 0.63 |

As shown in Table 5, more stain was released into the solution with 2 PPM and 10 PPM enzyme than in the no-enzyme control.

### Example 5. Odor Benefit of Fragrances

TABLE 6
Ingredients of an unscented model laundry detergent

| Chemical Description | Ingredient | Supplier | Percent |
|---|---|---|---|
| Sodium Dodecylbenzene Sulfonate | Biosoft ® La Acid | Innospec | 7.3 |
| Sodium Laureth Sulfate | Wilfares ® ESB 70 | Innospec | 6.3 |
| Potassium Cocoate | Nansa PC 38/F | Innospec | 1.05 |
| C12-15 Pareth-7 | Tomadol ® 25-7 | Evonik | 3 |
| Sodium Citrate | Sodium Citrate | Sigma | 2.65 |
| Ethanol | Ethanol | Sigma | 1 |
| Propylene Glycol | Propylene Glycol | Sigma | 2.5 |
| Glycerol | Glycerol | Sigma | 0.8 |
| Sorbitol | Sorbitol | Sigma | 0.8 |
| Triethanolamine | Triethanolamine | Sigma | 0.5 |
| Nonionic polyester | TexCare SRN 260 | Clariant | 0.3 |
| | liquid | | |
| Polycarboxylate | Acusol 420N powder | DOW | 1.38 |
| Polyvinylpyrrolidone | PVP K-30 liquid | ISP | 0.08 |
| Methylisothiazolinone + | ROCIMA ™ MBX | DuPont | 0.01 |
| Benzisothiazolinon | Biocide | | |
| Sodium hydroxide | | | 0.94 |
| | | water | to 100% |

A washing solution was prepared consisting of 2 g/L of the model detergent (Table 6) in deionized water, as well as fragrance (Skydive Mod, IFF) at the following concentrations: 0.001%, 0.0005%, 0.0002%, 0.0001%, and unfragranced. The samples were prepared by adding fragrance to aliquots of the model detergent and then dissolving the model detergent in water.

The solutions were put in scintillation vials (10 ml each). A volunteer odor sensory panel was asked to smell the solutions and score the solutions according to their perception of freshness (“How fresh does the sample smell?”) on a scale of 1 (neutral or not fresh) to 5 (very fresh) The results are shown in Table 7.

TABLE 7
Odor sensory panel evaluation of washing solutions
containing various fragrance concentrations.

| | Odor |
|---|---|
| Fragrance | panel score |
| dose | (n = 7) |
| 0 | 1 ± 0 |
| 0.1× | 3.1 ± 1.0 |
| 0.2× | 3.6 ± 1.3 |
| 0.5× | 4.4 ± 0.8 |
| 1× | 4.5 ± 0.8 |

As seen in Table 7, the panelists reported increased freshness relative to the unfragranced control at all concentrations tested.

### Example 6. Combinations of Metalloproteases with Fragrance Ingredients

Combinations of metalloproteases and specific fragrance ingredient classes are also contemplated here. A metalloprotease such as thermolysin or bacillolysin is combined with one or more fragrance ingredients such as tertiary alcohols (e.g. 2,6-dimethyl-7-octen-2-ol), secondary alcohols (e.g. 2-hydroxy bornane), primary alcohols (e.g. 3-methyl-5-phenyl-1-pentanol), ketones (e.g. damascone delta), nitriles (e.g. 3,7-dimethyl-6-octenenitrile) lactones (e.g. gamma undecalactone) aldehydes (e.g. undecanal), ethers (e.g. diphenyl oxide), or esters (e.g. isobornyl acetate).

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A method for treating malodor in a textile or machine comprising:
(i) contacting a textile or machine with a composition comprising:
a) 0.2 to 100 parts per million (PPM) of a polypeptide having thermolysin activity;
b) 0.00001% to about 2% of a fragrance; and
c) at least one detergent adjuvant, and
(ii) optionally rinsing the textile or machine.

2. The method of claim 1, wherein the machine is a laundry machine or a dishwasher.

3. The method of any of the preceding claims, wherein the composition comprises a polypeptide having thermolysin activity in an amount selected from 0.001 to 10,000 mg/L, or 0.001 to 2000 mg/L, or 0.01 to 5000 mg/L, or 0.01 to 2000 mg/L, or 0.01 to 1300 mg/L, or 0.1 to 5000 mg/L, or 0.1 to 2000 mg/L, or 0.1 to 1300 mg/L, or 1 to 5000 mg/L, or 1 to 1300 mg/L, or 1 to 500 mg/L, or 10 to 5000 mg/L, or 10 to 1300 mg/L, or 10 to 500 mg/L.

4. The method of any of the preceding claims, wherein the perfume is selected from the group consisting of alcohols, aldehydes, ketones, nitriles, lactones, ethers, esters, essential oils, and mixtures thereof.

5. The method of any of the preceding claims, wherein the composition is a laundry detergent composition.

6. A method for cleaning an item, comprising contacting an item in need of cleaning with a composition comprising a) 0.2 to 100 parts per million (PPM) of a polypeptide having thermolysin activity; b) 0.00001% to about 2% of a fragrance; and c) at least one detergent adjuvant, and (ii) optionally rinsing the item.

7. The method of claim 6, wherein the item is a textile or a hard surface.

8. The method of claim 7, wherein the hard surface is a laundry machine, dishware, or a dishwasher.

9. The method of any of claims 6-8, wherein the composition comprises a polypeptide having thermolysin activity in an amount selected from 0.001 to 10,000 mg/L, or 0.001 to 2000 mg/L, or 0.01 to 5000 mg/L, or 0.01 to 2000 mg/L, or 0.01 to 1300 mg/L, or 0.1 to 5000 mg/L, or 0.1 to 2000 mg/L, or 0.1 to 1300 mg/L, or 1 to 5000 mg/L, or 1 to 1300 mg/L, or 1 to 500 mg/L, or 10 to 5000 mg/L, or 10 to 1300 mg/L, or 10 to 500 mg/L.

10. The method of any of claims 6-9, wherein the perfume is selected from the group consisting of alcohols, aldehydes, ketones, nitriles, lactones, ethers, esters, essential oils, and mixtures thereof.

11. The method of any of claims 6-10, wherein the composition is a laundry detergent composition.

12. A method for improving the freshness of an item after a washing process, comprising contacting an item with a composition comprising a) 0.2 to 100 parts per million (PPM) of a polypeptide having thermolysin activity; b) 0.00001% to about 2% of a fragrance; and c) at least one detergent adjuvant, and (ii) optionally rinsing the item.

13. The method of claim 12, wherein the freshness of the item is improved after a washing process comparable to the item before the wash process, or comparable to a similar item after a washing process with a composition lacking (i) the polypeptide having thermolysin activity, (ii) the fragrance; or (iii) both the polypeptide having thermolysin activity and the perfume.

14. The method of any of the preceding claims, wherein the composition further comprises one or more additional enzymes selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hexosaminidases, hyaluronidases, keratinases, laccases, lactases, ligninases, lipases, lipoxygenases, lysozymes, mannanases, other metalloproteases, nucleases (e.g. deoxyribonucleases and ribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof.

15. Use of a polypeptide having thermolysin activity in a detergent composition for increasing the freshness associated with a perfume to a textile after a laundering process, or for enhancing the effect of a perfume in a detergent composition, wherein the detergent comprises at least one perfume compound.

16. Use according to claim 15, wherein the polypeptide having thermolysin activity is a polypeptide having at least about 60% sequence identity to SEQ ID NO: 1.

17. Use according to claims 15-16, wherein the detergent composition is a laundry detergent or a fabric softener.

18. Use according to claims 15-17 wherein the detergent composition further comprises a nuclease.

19. An enzyme-fragrance system comprising:
from about 0.2 to 100 PPM of a polypeptide having thermolysin activity; and
from about 0.00001% to about 2% of a fragrance.

20. A detergent composition comprising, from about 0.2 to 100 PPM of a polypeptide having thermolysin activity, from about 0.00001% to about 2% of a fragrance, and optionally at least one detergent adjunct materials.

21. The detergent composition of claim 20, wherein the composition further comprises one or more adjunct materials selected from the group consisting of builders, bleaches, bleach activators, bleach catalysts, other enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, and pH control agents.
